(19) United States
(12) Patent Application Publication
(10) Pub. No.: US 2023/0268559 A1
(43) Pub. Date: Aug. 24, 2023

(54) ANODELESS LITHIUM SECONDARY BATTERY AND METHOD OF MANUFACTURING THE SAME

(71) Applicants: Hyundai Motor Company, Seoul (KR); Kia Corporation, Seoul (KR); POSTECH Research and Business Development Foundation, Pohang (KR)

(72) Inventors: Sam Ick Son, Suwon (KR); Ki Yoon Bae, Seoul (KR); Sung Jin Cho, Seoul (KR); Soo Jin Park, Pohang (KR)

(21) Appl. No.: 18/078,833

(22) Filed: Dec. 9, 2022

(30) Foreign Application Priority Data
Feb. 18, 2022 (KR) 10-2022-0021162

(51) Int. Cl. H01M 10/42; H01M 10/0525; H01M 4/36; H01M 4/62; H01M 4/131

(52) U.S. Cl. CPC H01M 10/4214; H01M 4/131; H01M 4/366; H01M 4/622; H01M 10/0525; H01M 2220/20

(57) ABSTRACT

Disclosed are an anodeless lithium secondary battery having improved lithium utilization and a method of manufacturing the same. The lithium secondary battery includes an anode current collector, a composite layer disposed on the anode current collector, an intermediate layer disposed on the composite layer, a cathode active material layer disposed on the intermediate layer, and a cathode current collector disposed on the cathode active material layer. The composite layer includes a carbon component, metal particles capable of alloying with lithium, a polymer binder capable of binding to the metal particles through electrostatic attraction, and a solid electrolyte interfacial layer coated on the metal particles.

### CROSS-REFERENCE TO RELATED APPLICATION

This application claims under 35 U.S.C. §119(a) the benefit of priority to Korean Patent Application No. 10-2022-0021162, filed on Feb. 18, 2022, the entire contents of which are incorporated herein by reference.

### TECHNICAL FIELD

The present invention relates to an anodeless lithium secondary battery having improved lithium utilization and a method of manufacturing the same.

### BACKGROUND

As the demand for batteries rapidly increases and electric vehicles have been commercialized, the demand for the development of batteries that is capable of storing a large amount of energy has increased. In response thereto, many researches have been conducted on novel materials that can be used as an alternative of a graphite anode which has a limited capacity.

Lithium secondary batteries using lithium metal as an anode were first developed in the 1970s. Lithium metal was evaluated as an ideal anode material due to the large capacity and low voltage thereof.

Furthermore, anodeless batteries do not contain lithium metal or anode active materials and thus are considered as ideal lithium secondary batteries due to advantages in superior price competitiveness and greatly increased capacity per volume and weight. However, lithium is nonuniformly electrodeposited due to the high reactivity of lithium metal, and rapid capacity loss due to the limited use of lithium causes deterioration of battery performance and unstable lifespan property. However, as the advanced science and technology suggests various solutions and greatly alleviates the problems of anodeless batteries, interest therein is increasing.

Using a metal material capable of alloying with lithium or adding an additive to form a stable solid electrolyte interfacial layer is a well-known method for increasing lithium utilization. For example, additional lithium electrodeposition and desorption is facilitated when lithium ions form an alloy with a metal, thus lithium utilization is increased. In addition, lithium nitrate (LiNO₃) is decomposed to form a solid electrolyte interfacial layer including lithium nitride (Li₃N), lithium oxide (Li₂O), etc. having high ionic conductivity.

The above information disclosed in this Background section is only for enhancement of understanding of the background of the invention, and therefore it may contain information that does not form the prior art that is already known in this country to a person of ordinary skill in the art.

### SUMMARY

In preferred aspects, provided are an anodeless lithium secondary battery having improved lithium utilization and a method of manufacturing the same.

A term “anode-free lithium ion battery,” “anodeless lithium secondary battery,” “anode-free battery,” or “anodeless battery” as used herein refers to a lithium ion battery including a bare anode current collector or an anode current collector coated with a material inducing transfer or deposition of a lithium ion at its anode side. During the first charging of an anode-free cell, which is free of Li metal when initially assembled, Li metal is electroplated on the anode current collector.

The objects of the present invention are not limited to that described above. Other objects of the present invention will be clearly understood from the following description, and are able to be implemented by means defined in the claims and combinations thereof.

In one aspect, provided is a lithium secondary battery including an anode current collector, a composite layer disposed on the anode current collector, an intermediate layer disposed on the composite layer, a cathode active material layer disposed on the intermediate layer, and a cathode current collector disposed on the cathode active material layer. In particular, the composite layer may include a carbon component, metal particles capable of alloying with lithium, a polymer binder capable of binding to the metal particles, e.g., through electrostatic attraction, and a solid electrolyte interfacial layer coated on the metal particles.

The “carbon component” as used herein refers to elemental carbon material (e.g., graphite, coal, carbon nanotubes, fullerene or the like), which may be unmodified, modified with functional group or processed, or a compound (e.g., covalent compound, ionic compound, or salt) in including carbon constituting the dominant parts of weight of the compound.

The carbon component may include carbon black, acetylene black, graphene, or combinations thereof.

The metal particles may include one or more selected from the group consisting of gold (Au), platinum (Pt), palladium (Pd), silicon (Si), silver (Ag), aluminum (Al), bismuth (Bi), tin (Sn), and zinc (Zn).

The polymer binder may include branched polyethyleneimine (BPEI), polyvinylpyrrolidone (PVP), or combinations thereof.

The solid electrolyte interfacial layer may include Li₃N, LiO₂, Li₂O₂, or combinations thereof.

The intermediate layer may include a solid electrolyte layer or a separator.

The lithium secondary battery may further include an electrolyte impregnated in at least one of the intermediate layer and the cathode active material layer. Preferably, the electrolyte may include a lithium salt and a carbonate-based organic solvent.

A lithium metal may be deposited between the composite layer and the intermediate layer during charging.

In another aspect, provided is a method for manufacturing a lithium secondary battery. The method may include preparing a solution including a precursor of metal particles that are capable of alloying with lithium, a polymer binder capable of binding to the metal particles, e.g., through electrostatic attraction, and an additive, adding a carbon component to the solution to prepare a slurry, applying the slurry onto an anode current collector to form a composite layer, and forming a stack which the anode current collector, the composite layer, the intermediate layer, the cathode active material layer, and the cathode current collector are sequentially laminated.

A precursor of the metal particles may include a salt of the metal particles.

The additive may include LiNOs, and the additive may be decomposed to form a solid electrolyte interfacial layer coated on the metal particles.

The solution may include an amount of about 1 % to 20 % by weight of the polymer binder, an amount of about 1 % to 10 % by weight of the precursor of the metal particles, an amount of about 10 % to 30 % by weight of the additive, and a remaining amount of the solvent, based on the total weight of the solution.

The slurry may be prepared by adding an amount of about 50 to 200 parts by weight of the carbon component based on 100 parts by weight of the polymer binder to the solution.

The method may further include injecting an electrolyte into the stack.

Other aspects of the invention are discussed infra.

### BRIEF DESCRIPTION OF THE DRAWINGS

The above and other features of the present invention will now be described in detail with reference to certain exemplary embodiments thereof, illustrated in the accompanying drawings which are given hereinbelow by way of illustration only, and thus are not limitative of the present invention, and wherein:

FIG. 1 shows a cross-sectional view of an exemplary lithium secondary battery according to an exemplary embodiment of the present invention;

FIG. 2 shows an exemplary composite layer according to an exemplary embodiment of the present invention;

FIG. 3A shows the result of low-magnification transmission electron microscopy of a solution according to Example;

FIG. 3B shows the result of high-magnification transmission electron microscopy of the solution according to Example;

FIG. 3C shows the result of electron energy loss spectroscopy (EELS) of the lithium element (Li) in the solution according to Example;

FIG. 3D shows the electron energy loss spectrum for elemental silver (Ag) in the solution according to Example;

FIG. 3E shows the electron energy loss spectrum for elemental nitrogen (N) in the solution according to Example;

FIG. 4A shows the result of Li ls XPS analysis of the composite layers of Example and Comparative Examples 1 to 3;

FIG. 4B shows the result of N ls XPS analysis of the composite layers of Example and Comparative Examples 1 to 3;

FIG. 4C shows the result of O ls XPS analysis of the composite layers of Example and Comparative Examples 1 to 3; and

FIG. 5 shows the result of the lifespan of lithium secondary batteries according to Examples and Comparative Examples 1 to 4.

### DETAILED DESCRIPTION

The objects described above, as well as other objects, features and advantages, will be clearly understood from the following preferred embodiments with reference to the attached drawings. However, the present invention is not limited to the embodiments, and may be embodied in different forms. The embodiments are suggested only to offer a thorough and complete understanding of the disclosed context and to sufficiently inform those skilled in the art of the technical concept of the present invention.

It will be further understood that terms such as “comprise” or “has”, when used in this specification, specify the presence of stated features, integers, steps, operations, elements, components or combinations thereof, but do not preclude the presence or addition of one or more other features, integers, steps, operations, elements, components, or combinations thereof. In addition, it will be understood that, when an element such as a layer, film, region or substrate is referred to as being “on” another element, it can be directly on the other element, or an intervening element may also be present. It will also be understood that when an element such as a layer, film, region or substrate is referred to as being “under” another element, it can be directly under the other element, or an intervening element may also be present.

Unless the context clearly indicates otherwise, all numbers, figures and/or expressions that represent ingredients, reaction conditions, polymer compositions and amounts of mixtures used in the specification are approximations that reflect various uncertainties of measurement occurring inherently in obtaining these figures, among other things. For this reason, it should be understood that, in all cases, the term “about” should be understood to modify all such numbers, figures and/or expressions.

Further, unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

In addition, when numerical ranges are disclosed in the description, these ranges are continuous, and include all numbers from the minimum to the maximum, including the maximum within each range, unless otherwise defined. Furthermore, when the range refers to an integer, it includes all integers from the minimum to the maximum, including the maximum within the range, unless otherwise defined. In the present specification, when a range is described for a variable, it will be understood that the variable includes all values including the end points described within the stated range. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

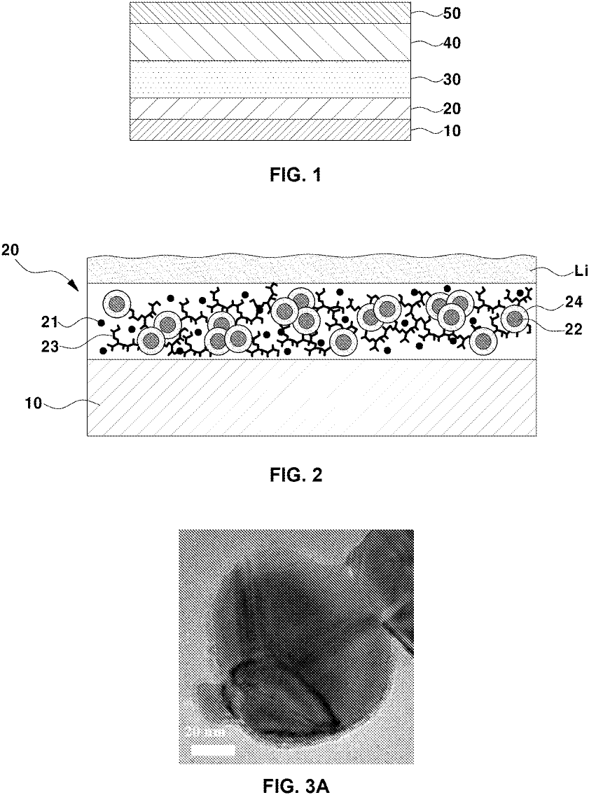

FIG. 1 shows a cross-sectional view of an exemplary lithium secondary battery according to an exemplary embodiment of the present invention. The lithium secondary battery may include a stack in which an anode current collector 10, a composite layer 20, an intermediate layer 30, a cathode active material layer 40, and a cathode current collector 50 are sequentially laminated.

The anode current collector 10 may be an electrically conductive plate-shaped substrate. The anode current collector 10 may include nickel (Ni), stainless steel (SUS), or combinations thereof.

The anode current collector 10 may include a metal thin film having porosity less than about 1% and high density.

The anode current collector 10 may have a thickness of about 1 µm to 20 µm, or particularly about 5 µm to 15 µm.

FIG. 2 illustrates a composite layer 20 according to the present invention. The composite layer 20 includes a carbon component 21, a metal particle 22 capable of alloying with lithium, a polymer binder 23 capable of binding to the metal particle 22 through electrostatic attraction, and a solid electrolyte interfacial layer 24 coated on the metal particle 22.

When the lithium secondary battery is charged, lithium metal (Li) may be electrodeposited on the composite layer 20, or particularly, between the composite layer 20 and the intermediate layer 30. The composite layer 20 may enable the lithium metal (Li) to be uniformly electrodeposited on and desorbed from the composite layer 20 during charging and discharging of the lithium secondary battery. When the composite layer 20 is not present, lithium metal (Li) is directly electrodeposited on the anode current collector 10. The high reactivity of the lithium metal (Li) may cause formation of lithium dendrites and inert lithium (dead lithium), thus adversely affecting the capacity and lifespan of the lithium secondary battery.

Particularly, the metal particles 22 can be uniformly distributed in the composite layer 20 by inducing bonding between the metal particles 22 and the polymer binder 23 through an electrostatic attraction.

In addition, after bonding between the metal particles 22 and the polymer binder 23, LiNO₃, is added as an additive and is thus adsorbed onto the surface of the metal particles 22. The additive adsorbed on the surface of the metal particles 22 may be decomposed to stably and uniformly form a solid electrolyte interfacial layer including Li₃N, LiO₂, or the like.

As a result, stable electrodeposition and desorption of lithium metal (Li) can be induced, and therefore the lithium secondary battery can be charged and discharged with high coulombic efficiency for a long time. In addition, high coulombic efficiency of the lithium secondary battery can be maintained even when an electrolyte having a wide voltage range is used, which enables combination with a cathode active material having a high operating voltage, thereby facilitating the increase in the energy density of a lithium secondary battery.

The carbon component 21 may include carbon black, acetylene black, graphene, or combinations thereof.

The metal particles 22 may include one or more selected from the group consisting of gold (Au), platinum (Pt), palladium (Pd), silicon (Si), silver (Ag), aluminum (Al), bismuth (Bi), tin (Sn), and zinc (Zn).

The polymer binder 23 may include branched polyethyleneimine (BPEI), polyvinylpyrrolidone (PVP), or combinations thereof.

The solid electrolyte interfacial layer 24 may include Li₃N, LiO_{2;} Li₂O₂, or combinations thereof.

The intermediate layer 30 may include a solid electrolyte layer or a separator.

The solid electrolyte layer may conduct lithium ions between the composite layer 20 and the cathode active material layer 40.

The solid electrolyte layer may include a solid electrolyte having lithium ion conductivity. The solid electrolyte may include an oxide-based solid electrolyte or a sulfide-based solid electrolyte. However, it is preferable to use a sulfide-based solid electrolyte having high lithium ion conductivity. The sulfide-based solid electrolyte is not particularly limited, and may include Li₂S-P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (wherein m and n are positive numbers and Z is one of Ge, Zn, and Ga), Li₂S—GeS₂, Li₂S—SiS₂—Li₃PO₄, Li₂S—SiS₂—LiₓMO_{y} (wherein x and y are positive numbers and M is one of P, Si, Ge, B, Al, Ga, and In), Li₁₀GeP₂S₁₂, or the like.

The separator may prevent physical contact between the composite layer 20 and the cathode active material layer 40.

The separator may include polypropylene.

The cathode active material layer 40 may include a cathode active material, a solid electrolyte, a conductive material, a binder, and the like.

The cathode active material may include an oxide active material or a sulfide active material.

The oxide active material may include a rock-salt-layer-type active material such as LiCoO₂, LiMnO₂, LiNiO₂, LiVO₂, or Li₁₊ₓNi_{1/3}Co_{1/3}Mn_{1/3}O₂, a spinel-type active material such as LiMn₂O₄ or Li(Ni_{0.5}Mn_{1.5})O₄, a reverse-spinel-type active material such as LiNiVO₄ or LiCoVO₄, an olivine-type active material such as LiFePO₄, LiMnPO₄, LiCoPO₄, or LiNiPO₄, a silicon-containing active material such as Li₂FeSiO₄ or Li₂MnSiO₄, a rock-salt-layer-type active material having a transition metal, a portion of which is substituted with a heterogeneous metal such as LiNi_{0.8}Co_{(0.2-x)}AlₓO₂ (0 < x < 0.2), a spinel-type active material having a transition metal, a portion of which is substituted with a heterogeneous metal such as Li₁₊ₓMn_{2-x-y}M_{y}O₄ (wherein M includes at least one of Al, Mg, Co, Fe, Ni, Zn, and 0<x+y<2), and lithium titanate, such as Li₄Ti₅O₁₂.

The sulfide active material may include copper Chevrel, iron sulfide, cobalt sulfide, nickel sulfide, or the like.

The solid electrolyte may include an oxide solid electrolyte or a sulfide solid electrolyte. However, preferred is the use of a sulfide solid electrolyte, which has high lithium ion conductivity. The sulfide solid electrolyte is not particularly limited, but may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (wherein m and n are positive numbers and Z is one of Ge, Zn and Ga), Li₂S—GeS₂, Li₂S—SiS₂—Li₃PO₄, Li₂S—SiS₂—LiₓMO_{y} (wherein x and y are positive numbers and M is one of P, Si, Ge, B, Al, Ga, and In), Li₁₀GeP₂S₁₂, or the like.

The conductive material may include carbon black, conductive graphite, graphene, or the like.

The binder may include butadiene rubber (BR), nitrile butadiene rubber (NBR), hydrogenated nitrile butadiene rubber (HNBR), polyvinylidene difluoride (PVDF), polytetrafluoroethylene (PTFE), carboxymethylcellulose (CMC), or the like.

The cathode current collector 50 may be an electrically conductive plate-shaped substrate. The cathode current collector 50 may include aluminum foil.

The lithium secondary battery may further include an electrolyte (not shown) impregnated in at least one of the intermediate layer 30 and the cathode active material 40.

The electrolyte may include a lithium salt, organic solvent or the like.

Any lithium salt may be used without particular limitation, as long as it is one that is ordinarily used in the field to which the present invention pertains, and the lithium salt may, for example, include at least one selected from the group consisting of LiPF₆, LiBF₄, LiClO₄, LiSbF₆, LiAsF₆, LiN(SO₂C₂F₅)₂, LiN(CF₃SO₂)₂, LiN(SO₃C₂F₅)₂, LiN(SO₂F)₂, LiCF₃SO₃, LiC₄F₉SO₃, LiC₆H₅SO₃, LiSCN, LiAlO₂, LiAlCl₄, LiN(CₓF₂ₓ₊₁SO₂)(C_{y}F_{2y+1}SO₂) (wherein x and y are natural numbers), LiCl, LiI, and LiB(C₂O₄)_{2.}

The organic solvent may include any organic solvent conventionally used in the technical field to which the present invention pertains. However, the organic solvent preferably includes a carbonate-based organic solvent having a wide operating voltage range in order to allow combination with a cathode active material having a high operating voltage. The organic solvent may include at least one selected from the group consisting of ethylene carbonate, propylene carbonate, dimethyl carbonate, diethyl carbonate, butylene carbonate, ethyl methyl carbonate, fluoroethylene carbonate, methyl propyl carbonate, ethyl propyl carbonate, methyl isopropyl carbonate, dipropyl carbonate, dibutyl carbonate, and combinations thereof.

The electrolyte may further include an electrolyte additive such as vinylene carbonate or fluoroethylene carbonate, if necessary.

In method for manufacturing a lithium secondary battery includes preparing a solution containing a precursor of metal particles capable of alloying with lithium, a polymer binder capable of binding to the metal particles through electrostatic attraction, and an additive, and adding a carbon component to the solution to prepare a slurry, applying the slurry onto an anode current collector to form a composite layer, and forming a stack which the anode current collector, the composite layer, the intermediate layer, the cathode active material layer, and the cathode current collector are sequentially laminated. In addition, the manufacturing method may further include injecting an electrolyte into the structure.

The solution may be prepared by adding the polymer binder and the precursor of metal particles to the solvent, followed by allowing the reaction to proceed and then adding the additive to resultant of the reaction.

The solvent is not particularly limited and may include, for example, an aqueous solvent.

The precursor of the metal particles may include a salt of the aforementioned metal particles. For example, the precursor may include a nitrate, hydrochloride, sulfate, or the like of the metal contained in the metal particles.

The additive may be adsorbed onto the metal particles, and may be decomposed to form the solid electrolyte interfacial layer. The additive may include LiNO₃.

The solution may include an amount of about 1 % to 20 % by weight of the polymer binder, an amount of about 1 % to 10 % by weight of the precursor of the metal particles, an amount of about 10 % to 30 % by weight of the additive, and the remaining amount of the solvent, % by weight based on the total weight of the solution.

A carbon component may be added to the solution to form a slurry. The slurry may be prepared by adding the carbon component in an amount of about 50 to 200 parts by weight based on 100 parts by weight of the polymer binder to the solution.

The slurry may be applied onto the anode current collector, followed by drying, to form the composite layer.

The method of manufacturing the stack is not particularly limited, and the stack may be formed by sequentially laminating the intermediate layer, the cathode active material layer, and the cathode current collector on the composite layer.

### EXAMPLE

Hereinafter, the present invention will be described in more detail with reference to specific examples. However, the following examples are provided only for better understanding of the present invention, and thus should not be construed as limiting the scope of the present invention.

### Example

Branched polyethyleneimine (BPEI) as a polymer binder was added to water (H₂O) as a solvent, and then AgNO₃ was added as a precursor of metal particles. The resultant was stirred at a temperature of about 80° C. for about 24 hours, LiNO₃ was added thereto as an additive, and the mixture was stirred at room temperature for about 30 minutes or longer to prepare a solution. The solution contained 9% by weight of a polymer binder, 6% by weight of AgNO₃, 20% by weight of LiNO₃, and the balance of water.

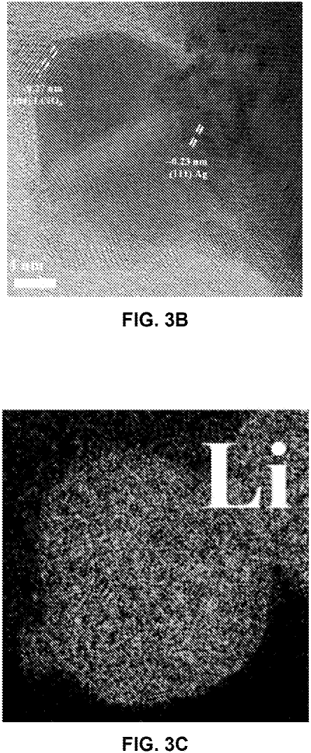

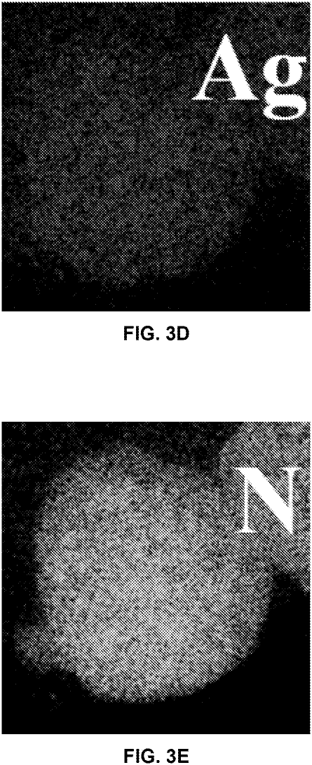

FIG. 3A shows the result of low-magnification transmission electron microscopy of the solution. FIG. 3B shows the result of high-magnification transmission electron microscopy of the solution. FIG. 3C shows the result of electron energy loss spectroscopy (EELS) of the lithium element (Li) in the solution. FIG. 3D shows the electron energy loss spectrum for elemental silver (Ag) in the solution. FIG. 3E shows the electron energy loss spectrum for elemental nitrogen (N) in the solution. As shown in FIGS. 3A-3E, the lithium element, the silver element, and the nitrogen element may be distributed at substantially the same positions, which means that the additive and the resulting solid electrolyte interfacial layer may be adsorbed on the surface of the metal element.

100 parts by weight of Super-C, which is a carbon component, was added to the solution based on 100 parts by weight of the polymer binder to form a slurry.

The slurry was applied onto an anode electrode current collector including copper using doctor-blade coating and dried at a temperature of about 120° C. under vacuum for about 4 hours to form a composite layer.

The cathode active material LiNi_{0.8}Co_{0.1}Mn_{0.1}O₂ a conducting agent, and polyvinylidene fluoride (PVDF) as a binder were added to N-methylpyrrolidone to prepare a slurry, and the slurry was applied and dried on a substrate to form a cathode active material layer. A cathode current collector was attached to the cathode active material layer.

A polypropylene separator was interposed between the cathode active material layer and the composite layer to prepare a structure.

An electrolyte was injected into the stack to manufacture a lithium secondary battery. The electrolyte used herein contained 1 M LiPF₆ as a lithium salt in an organic solvent containing a mixture of ethylene carbonate and diethyl carbonate at a weight ratio of 3:7, and 10% by weight of fluoroethylene carbonate (FEC) as an electrolyte additive.

### Comparative Example 1

A composite layer and a lithium secondary battery were manufactured in substantially the same manner as in Example except that a solution was prepared without adding AgNO₃ as a precursor of metal particles, and LiNO₃ as an additive.

### Comparative Example 2

A composite layer and a lithium secondary battery were manufactured in substantially the same manner as in Example except that a solution was prepared without adding AgNO₃ as a precursor of metal particles.

### Comparative Example 3

A composite layer and a lithium secondary battery were manufactured in substantially the same manner as in Example, except that a solution was prepared without adding LiNO₃ as a precursor of metal particles.

### Comparative Example 4

A lithium secondary battery was manufactured in substantially the same manner as in Example except that a polypropylene separator, a cathode active material layer, and a cathode current collector were laminated on the anode current collector without forming a composite layer.

### Experimental Example 1

The composite layers of Examples and Comparative Examples 1 to 3 were analyzed by X-ray photoelectron spectroscopy (XPS).

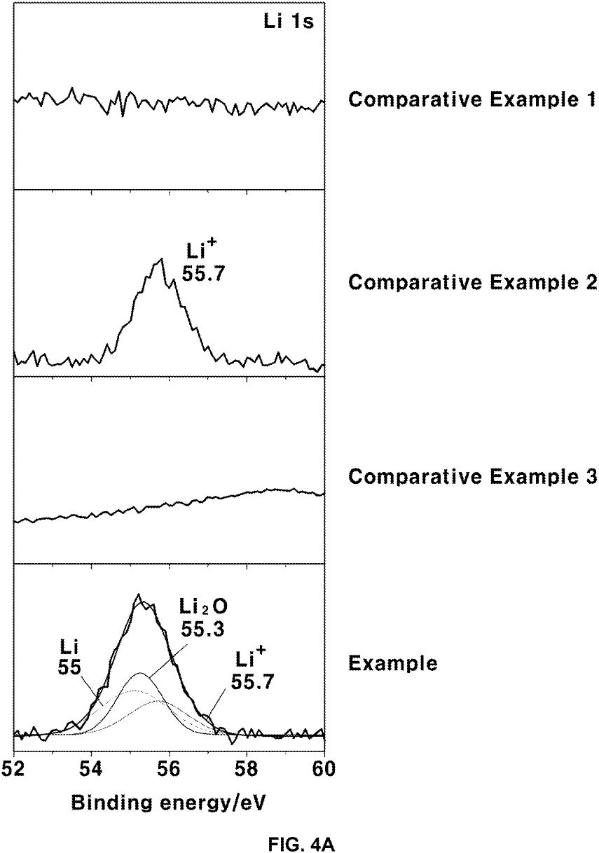

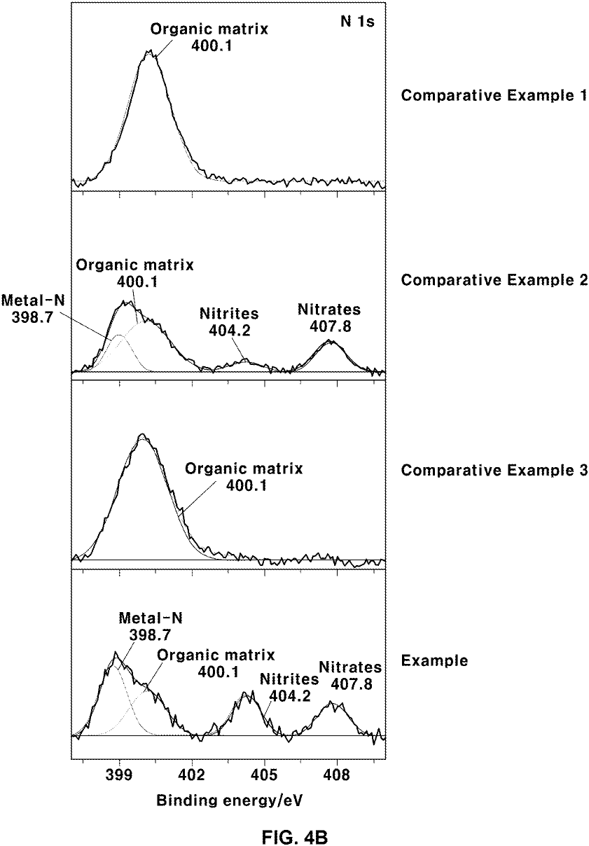

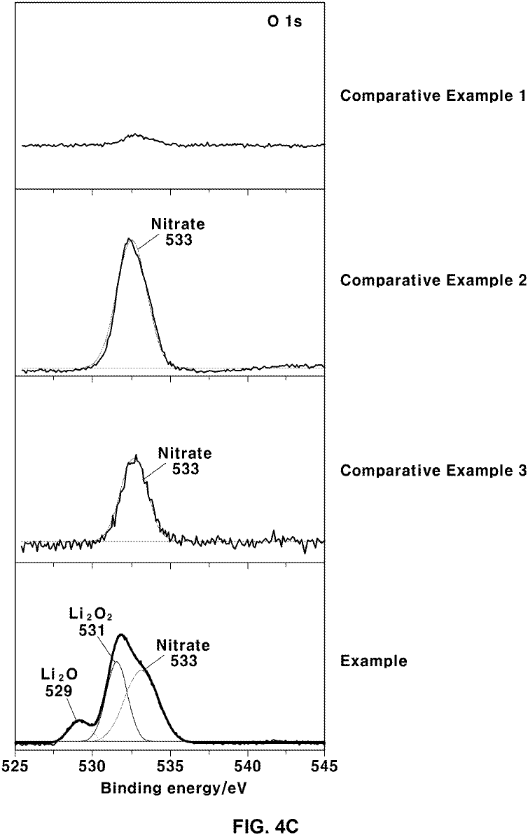

FIG. 4A shows the result of Li 1 s XPS analysis. FIG. 4B shows the result ofN 1 s XPS analysis. FIG. 4C shows the result of O 1 s XPS analysis. As can be seen from FIGS. 4A and 4C, peaks corresponding to components such as Li₂O and Li₂O₂ in the solid electrolyte interfacial layer were observed only in the composite layer according to Example. In addition, it can be seen from FIG. 4B that a peak corresponding to the combination of the elemental silver (Ag) and elemental nitrogen (N) in the metal particles in the composite layer of Example was observed.

The result showed that, according to the present invention, the solid electrolyte interfacial layer can be evenly formed on the surface of the metal particles.

### Experimental Example 2

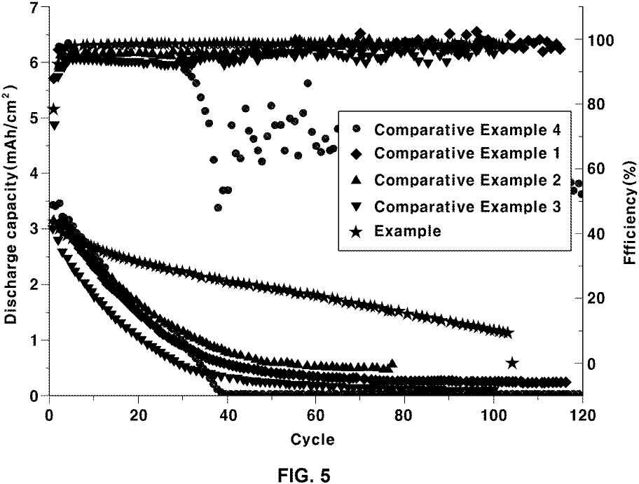

The lithium secondary batteries according to Examples and Comparative Examples 1 to 4 were charged and discharged at a charge rate of 0.5 C and a discharge rate of 0.5 C. The capacity was about 3.8 mAh/cm², and the cut-off condition was 3 V to 4.3 V. FIG. 5 shows the result of the lifespan of lithium secondary batteries according to Examples and Comparative Examples 1 to 4. As can be seen from FIG. 5, Example exhibits significantly superior lifespan characteristics compared to Comparative Examples 1 to 4.

According to various exemplary embodiments of the present invention, a lithium secondary battery having excellent electrochemical properties, such as lithium utilization and lifespan, may be obtained.

According to various exemplary embodiments of the present invention, a lithium secondary battery having high energy density may be obtained.

The effects of the present invention are not limited to those mentioned above. It should be understood that the effects of the present invention include all effects that can be inferred from the description of the present invention.

The present invention has been described in detail with reference to embodiments thereof. However, it will be appreciated by those skilled in the art that changes may be made in these embodiments without departing from the principles and spirit of the present invention, the scope of which is defined in the appended claims and their equivalents.

What is claimed is:

1. A lithium secondary battery comprising:
an anode current collector;
a composite layer disposed on the anode current collector;
an intermediate layer disposed on the composite layer;
a cathode active material layer disposed on the intermediate layer; and
a cathode current collector disposed on the cathode active material layer,
wherein the composite layer comprises:
a carbon component;
metal particles capable of alloying with lithium;
a polymer binder capable of binding to the metal particles; and
a solid electrolyte interfacial layer coated on the metal particles.

2. The lithium secondary battery according to claim 1, wherein the carbon component comprises carbon black, acetylene black, graphene, or combinations thereof.

3. The lithium secondary battery according to claim 1, wherein the metal particles comprise one or more selected from the group consisting of gold (Au), platinum (Pt), palladium (Pd), silicon (Si), silver (Ag), aluminum (Al), bismuth (Bi), tin (Sn), and zinc (Zn).

4. The lithium secondary battery according to claim 1, wherein the polymer binder comprises branched polyethyleneimine (BPEI), polyvinylpyrrolidone (PVP), or combinations thereof.

5. The lithium secondary battery according to claim 1, wherein the solid electrolyte interfacial layer comprises Li₃N, LiO₂, Li₂O₂, or any combination thereof.

6. The lithium secondary battery according to claim 1, wherein the intermediate layer comprises a solid electrolyte layer or a separator.

7. The lithium secondary battery according to claim 1, wherein the lithium secondary battery further comprises an electrolyte impregnated in at least one of the intermediate layer and the cathode active material layer, and
the electrolyte comprises a lithium salt and a carbonate-based organic solvent.

8. The lithium secondary battery according to claim 1, wherein a lithium metal is deposited between the composite layer and the intermediate layer during charging.

9. A method for manufacturing a lithium secondary battery, comprising:
preparing a solution comprising a precursor of metal particles that are capable of alloying with lithium, a polymer binder capable of binding to the metal particles, and an additive;
adding a carbon component to the solution to prepare a slurry;
applying the slurry onto an anode current collector to form a composite layer; and
forming a stack which the anode current collector, the composite layer, an intermediate layer, a cathode active material layer, and a cathode current collector are sequentially laminated.

10. The method according to claim 9, wherein the metal particles comprise one or more selected from the group consisting of gold (Au), platinum (Pt), palladium (Pd), silicon (Si), silver (Ag), aluminum (Al), bismuth (Bi), tin (Sn), and zinc (Zn), wherein a precursor of the metal particles comprises a salt of the metal particles.

11. The method according to claim 9, wherein the polymer binder comprises branched polyethyleneimine (BPEI), polyvinylpyrrolidone (PVP), or combinations thereof.

12. The method according to claim 9, wherein the additive comprises LiNO₃, the additive is decomposed to form a solid electrolyte interfacial layer coated on the metal particles, and
the solid electrolyte interfacial layer comprises at least one of Li₃N, LiO₂, Li₂O₂, or any combination thereof.

13. The method according to claim 9, wherein the solution comprises:
an amount of about 1% to 20% by weight of the polymer binder;
an amount of about 1% to 10% by weight of the precursor of the metal particles;
an amount of about 10% to 30% by weight of the additive; and
a remaining amount of the solvent,
% by weight based on the total weight of the solution.

14. The method according to claim 9, wherein the carbon component comprises carbon black, acetylene black, graphene, or combinations thereof.

15. The method according to claim 9, wherein the slurry comprises an amount of about 50 to 200 parts by weight of the carbon component based on 100 parts by weight of the polymer binder to the solution.

16. The method according to claim 9, wherein the intermediate layer comprises a solid electrolyte layer or a separator.

17. The method according to claim 9, further comprising injecting an electrolyte to the stack, wherein the electrolyte comprises a lithium salt and a carbonate-based organic solvent.

18. The method according to claim 9, wherein a lithium metal is deposited between the composite layer and the intermediate layer during charging.

19. A vehicle comprising a lithium secondary battery according to claim 1.
